(19) United States
(12) Patent Application Publication
(10) Pub. No.: US 2014/0162165 A1
(43) Pub. Date: Jun. 12, 2014

(54) FUEL CELL STACK INCLUDING COOLING PLATE FOR IMPROVING TEMPERATURE DISTRIBUTION

(71) Applicant: Samsung Electronics Co., Ltd., Suwon-si (KR)

(72) Inventors: Tae-won SONG, Yongin-si (KR); Jeong-sik KO, Yongin-si (KR); Ji-rae KIM, Yongin-si (KR); Jin-ho KIM, Yongin-si (KR)

(73) Assignee: Samsung Electronics Co., Ltd., Suwon-si (KR)

(21) Appl. No.: 13/962,461

(22) Filed: Aug. 8, 2013

(30) Foreign Application Priority Data
Dec. 11, 2012 (KR) 10-2012-0143832

(51) Int. Cl. H01M 8/04

(52) U.S. Cl. CPC H01M 8/04067
USPC 429/465

(57) ABSTRACT

A fuel cell stack includes a first separating plate, a second separating plate corresponding to the first separating plate, a plurality of cells comprising a membrane electrode assembly disposed between the first separating plate and the second separating plate, and a cooling plate disposed between the plurality of cells, where a cooling channel is defined at opposing surfaces of the cooling plate.

### CROSS-REFERENCE TO RELATED APPLICATIONS

This application claims priority to Korean Patent Application No. 10-2012-0143832, filed on Dec. 11, 2012, and all benefits accruing therefrom under 35 U.S.C. §119, the content of which in its entirety is herein incorporated by reference.

### BACKGROUND

1. Field

The disclosure relates to a fuel cell stack, and more particularly, to a fuel cell stack including a cooling plate for improving temperature distribution.

2. Description of the Related Art

Due to corrosion by phosphate, a separating plate made of metal (hereinafter, metal separating plate) may not be effectively used in a polymer electrolyte membrane fuel cell (“PEMFC”). Therefore, a resin-carbon separating plate is generally used instead of a metal separating plate in a PEMFC. In addition, a resin-carbon separating plate is used as a cooling plate to absorb heat generated during an electrochemical reaction.

The cooling plate may include two plates adhered to each other. Each of opposing sides of the two plates is respectively provided with a channel. However, the thickness of a coupling plate in the form of two adhered plates is generally thicker than that of a metal separating plate, thus increasing the volume of the fuel cell.

In addition, when cooling water at low temperature flows into the cooling plate and cooling water having a high temperature flows out from the cooling plate, a temperature distribution is generated along the cooling channel, thereby generating non-uniformity in terms of temperature within the cooling plate. This affects the temperature of the neighboring separating plate and a membrane electrode assembly (“MEA”), thereby temporarily deteriorating the function of the MEA and also the long term durability of MEA.

### SUMMARY

Provided is a fuel cell stack including a cooling plate with improved uniformity of a temperature distribution of the stack.

According to an embodiment of the invention, a fuel cell stack includes a first separating plate, a second separating plate provided corresponding to the first separating plate, a plurality of cells including a membrane electrode assembly (“MEA”) disposed between the first separating plate and the second separating plate, and a cooling plate disposed between the plurality of cells, where a cooling channel is defined at opposing surfaces of the cooling plate.

In an embodiment, the fuel cell stack may further include a blocking plate disposed between the cooling plate and a cell neighboring the cooling plate.

In an embodiment, the cooling channel may include a first cooling channel defined in a first surface of the cooling plate and a second cooling channel defined in a second surface of the cooling plate, and the first and second cooling channels are arranged such that a high temperature portion of the first cooling channel may correspond to a low temperature portion of the second cooling channel.

In an embodiment, the first cooling channel and the second cooling channel may have a zigzag shape.

In an embodiment, the first cooling channel and the second cooling channel may be arranged in a crisscross, interdigitated, biomimetic or fractal form.

In an embodiment, a direction of a coolant flowing through the first cooling channel in a predetermined region of the cooling plate may be substantially the same as or substantially opposite to a direction of a coolant flowing through the second cooling channel in the predetermined region of the cooling plate.

In an embodiment, a width of the first cooling channel may be substantially the same as or different from a width of the second cooling channel.

In an embodiment, at least one of the first cooling channel and the second cooling channel may have a channel density which varies depending on a region.

In an embodiment, the first cooling channel and the second cooling channel may include an inclined portion.

In an embodiment, input terminals of both the first cooling channel and the second cooling channel may be connected to a same manifold.

In an embodiment, output terminals of the first cooling channel and the second cooling channel may be connected to a same manifold or different manifolds.

In an embodiment, the input terminals of the first cooling channel and the second cooling channel may be connected to different manifolds. In an embodiment, the output terminals of the first cooling channel and the second cooling channel may be connected to the same manifold or different manifolds.

In such embodiments, the fuel cell stack including a cooling plate for improving a temperature distribution includes cooling channels defined in opposing surfaces of the cooling plate. The cooling channels are arranged such that a low temperature region provided in one of the cooling plates may correspond to a high temperature region provided in another cooling plate, and the temperature distribution in a cooling water inlet and a cooling water outlet of the cooling plates is thereby improved. In such embodiments, a substantially uniform temperature distribution may be generated over the entire region of the cooling plates, thereby improving an MEA performance and durability of the fuel cell.

### BRIEF DESCRIPTION OF THE DRAWINGS

These and/or other features will become apparent and more readily appreciated from the following description of the embodiments, taken in conjunction with the accompanying drawings, in which:

FIG. 1 is an exploded sectional view of an embodiment of a fuel cell stack including a cooling plate for improving a temperature distribution, according to the invention;

FIG. 2 is an enlarged sectional view of a first region A1 of an embodiment of a cooling plate of FIG. 1;

FIG. 3 is an enlarged sectional view of the first region A1 of an alternative embodiment of the cooling plate of FIG. 1;

FIG. 4 is a sectional view illustrating an embodiment of a membrane electrode assembly (“MEA”) of FIG. 1;

FIG. 5 is an exploded sectional view of an alternative embodiment of a fuel cell stack including a cooling plate for improving a temperature distribution, according to the invention;

FIG. 6 is a sectional view illustrating the fuel cell stack of FIG. 5 in a coupled state;

FIGS. 7 to 13 are sectional views illustrating various embodiments of cooling channels in a cooling plate of the fuel cell stacks of FIGS. 1 to 5; and

FIGS. 14 to 26 are plan views illustrating shapes of various embodiments of a cooling channel in a cooling plate of a fuel cell stack, according to the invention.

### DETAILED DESCRIPTION

The invention will be described more fully hereinafter with reference to the accompanying drawings, in which embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, embodiments of a fuel cell stack including a cooling plate for improving temperature distribution will be described in further details with reference to the accompanying drawings.

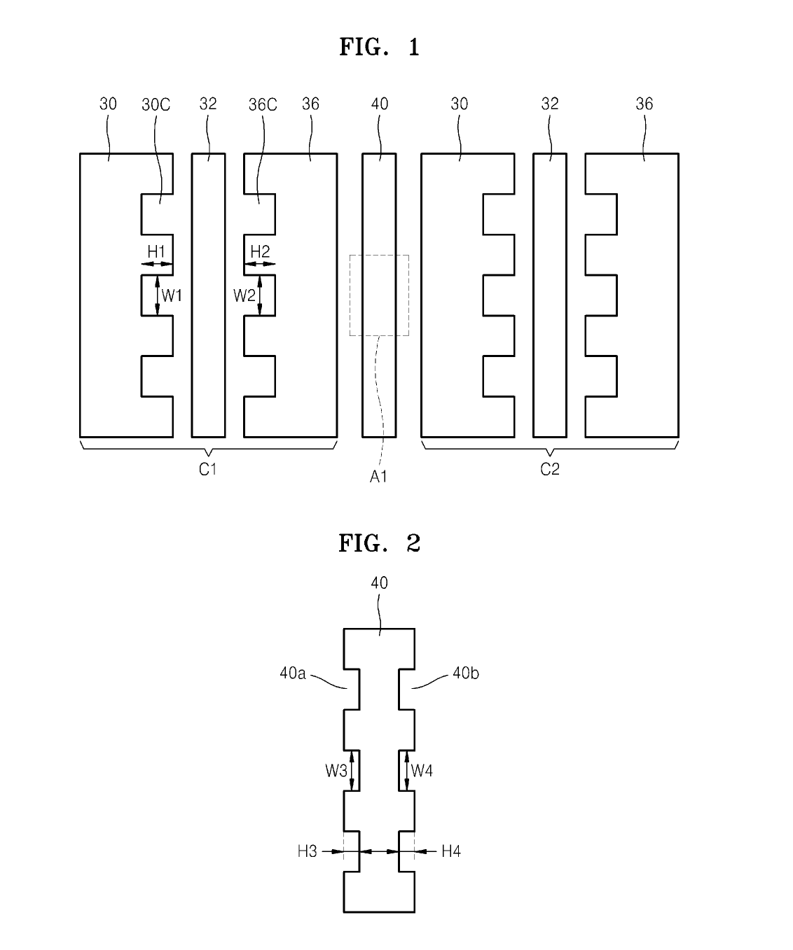

FIG. 1 is an exploded sectional view of an embodiment of a fuel cell stack including a cooling plate for improving a temperature distribution, according to the invention. FIG. 1 may be a cross-sectional view cut perpendicular to supply channels that are for supplying fuel and air and formed in the separating plate of the stack.

Referring to FIG. 1, in an embodiment, the fuel cell stack includes first and second cells C1 and C2. In an embodiment, the fuel cell stack may include two or more cells, only two cells, e.g., the first and second cells C1 and C2, are shown in FIG. 1 for convenience of illustration. In such an embodiment, a cooling plate 40 is provided between the first and second cells C1 and C2. In one embodiment, for example, the cooling plate 40 may be a carbon-resin cooling plate, but not being limited thereto. The cooling plate 40 is in contact with the first and second cells C1 and C2. In one embodiment, for example, the cooling plate 40 may be in contact with the first and second cells C1 and C2 by a sealing. A cooling channel is defined in surface of the cooling plate 40 both in a side which contacts the first cell C1 and a side which contacts the second cell C2. The cooling plate 40 will be described later in greater detail. A blocking plate (not shown) may be further provided between the cooling plate 40 and a cell neighboring the cooling plate 40.

In an embodiment, each of the first and second cells C1 and C2 includes a first separating plate 30 and a second separating plate 36. A membrane electrode assembly (“MEA”) 32 is provided between the first and the second separating plates 30 and 36. The MEA 32 includes an anode to which a fuel is supplied and a cathode to which air is supplied. In one embodiment, for example, the fuel may be hydrogen (H₂). A plurality of first channels 30C is provided in the side of the first separating plate 30 that faces the MEA 32. A plurality of second channels 36C is provided in the side of the second separating plate 36 that faces the MEA 32. The first and second channels 30C and 36C are covered by the MEA 32. The first channels 30C may have a first width W1 and a first depth H1. The second channels 36C may have a second width W2 and a second depth H2. In an embodiment, the first width W1 and the second width W2 may be substantially the same as or different from each other. The first depth H1 and the second depth H2 may be substantially the same as or different from each other. A fuel gas, for example a hydrogen gas, may be supplied through the first channels 30C. Air or an oxygen gas may be supplied through the second channels 36C.

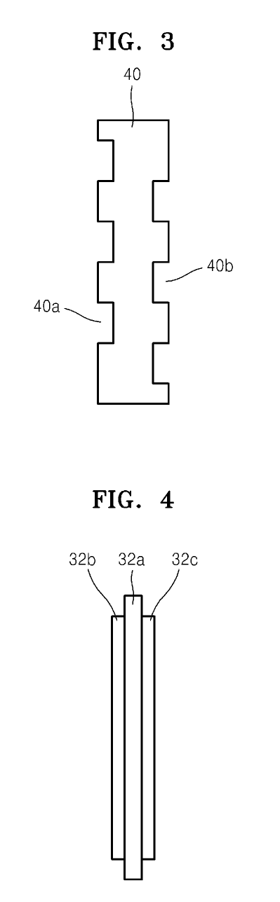

FIG. 2 is an enlarged sectional view of a first region A1 of an embodiment of a cooling plate 40 of FIG. 1, and FIG. 3 is an enlarged sectional view of the first region A1 of an alternative embodiment of the cooling plate of FIG. 1.

Referring to FIG. 2, in an embodiment of the invention, a plurality of first cooling channels 40a is defined in a first side (e.g., the left of FIG. 2) of the cooling plate 40, and a plurality of second cooling channels 40b is defined in the second side (e.g., the right of FIG. 2) of the cooling plate 40. In such an embodiment, the cooling plate 40 may include cooling channels defined, e.g., formed, on opposing sides thereof. In an embodiment, the first cooling channels 40a may be interconnected to each other, and thereby collectively define a single channel. In an embodiment, the second cooling channels 40b may be interconnected to each other, and thereby collectively define a single channel. The first side of the cooling plate 40 may face the second separating plate 36 of the first cell C1, and the second side of the cooling plate 40 may face the first separating plate 30 of the second cell C2. In an embodiment, the first cooling channel 40a may be covered by the second separating plate 36 of the first cell C1, and the second cooling channel 40b may be covered by the first separating plate 30 of the second cell C2. Cooling water, cooling oil or the like may be supplied through the first and second cooling channels 40a and 40b to transfer heat generated in the fuel cell stack. The first cooling channel 40a may have a third width W3 and a third depth H3. The second cooling channel 40b may have a fourth width W4 and a fourth depth H4. The third width W3 and the fourth width W4 may be substantially the same as or different from each other. The third depth H3 and the fourth depth H4 may be substantially the same as or different from each other. In an embodiment, as shown in FIG. 2, the first and second cooling channels 40a and 40b may be defined, e.g., formed, in locations opposite to each other.

In an alternative embodiment, the first and second cooling channels 40a and 40b may be defined in locations which are not opposite to each other, as shown in FIG. 3. In such an embodiment, the second cooling channel 40b may be located between the first cooling channels 40a.

FIG. 4 shows a sectional view illustrating an embodiment of the MEA 32 of FIG. 1. FIG. 4 schematically shows one embodiment of the MEA 32 according to the invention, and the configuration of the MEA 32 is not limited to that shown in FIG. 4.

Referring to FIG. 4, in an embodiment, the MEA 32 may include an electrolyte membrane 32a, a first electrode 32b and a second electrode 32c disposed opposite to the first electrode 32b, and the electrolyte membrane 32a is disposed between the first and second electrodes 32b and 32c.

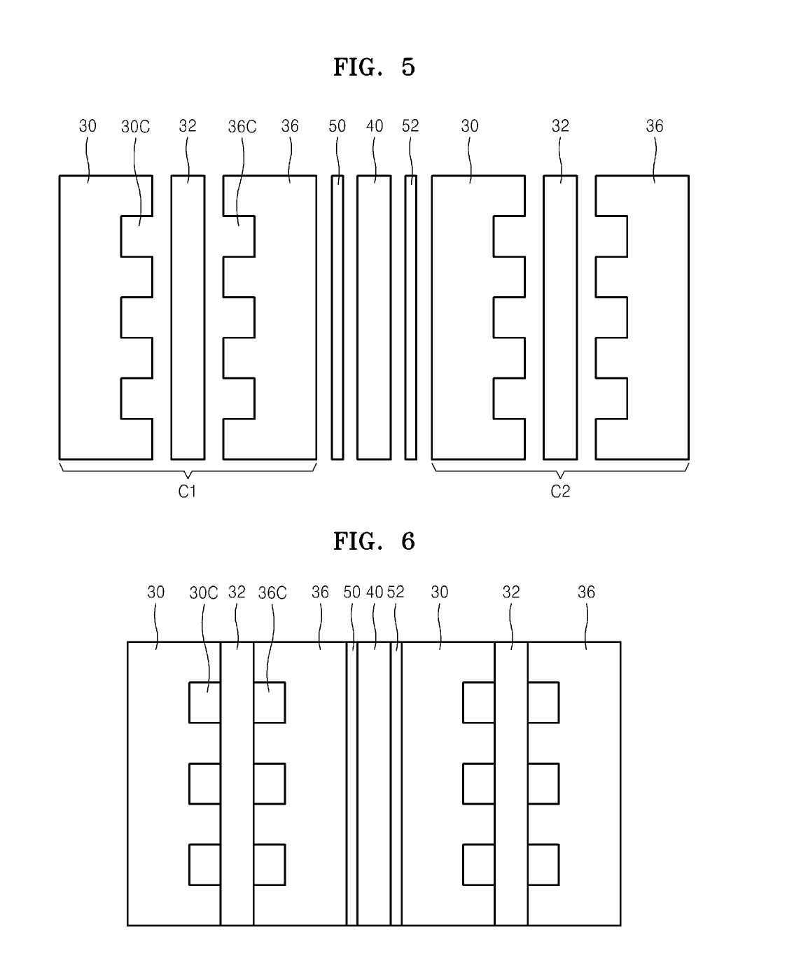

FIG. 5 shows an alternative embodiment of a fuel cell stack including a cooling plate for improving a temperature distribution, according to the invention.

Referring to FIG. 5, a first plate 50 is disposed between the first cell C1 and the cooling plate 40, and a second plate 52 is disposed between the second cell C2 and the cooling plate 40. In such an embodiment, the first and second plates 50 and 52 may be in contact with neighboring cells, respectively, and with the cooling plate 40, thereby covering the first and second cooling channels 40a and 40b. The first and second plates 50 and 52 are in sealed contact with the cooling plate 40, thereby effectively preventing a leakage of a coolant (e.g., oil or water) flowing through the first and second cooling channels 40a and 40b. The rest of the configuration of the embodiment of the fuel cell stack shown in FIG. 5 is substantially the same as in the embodiment of the fuel cell stack illustrated in FIG. 1.

FIG. 6 is a sectional view illustrating the fuel cell stack of FIG. 5 in a coupled state. FIG. 6 shows the fuel cell stack of FIG. 5 in a coupled state, in which the first cell C1, the second cell C2, the cooling plate 40, and the first and the second plates 50 and 52 are in close contact with each other.

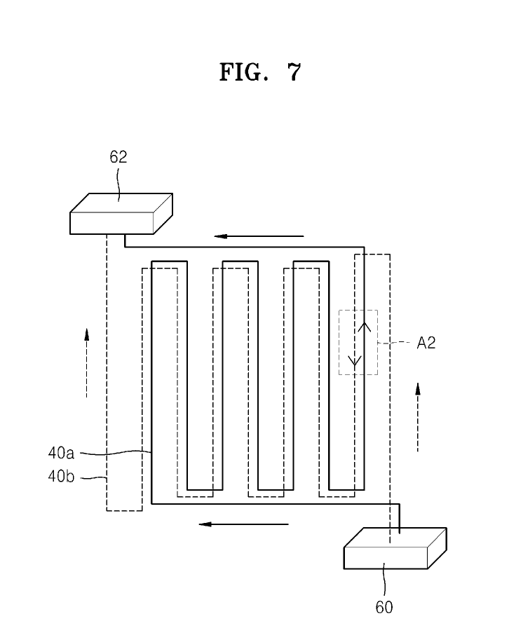

FIGS. 7 to 12 show various embodiments of the first and second cooling channels 40a and 40b in the cooling plate 40. The invention is not limited to the embodiments shown in FIGS. 7 to 12, and the first and second cooling channels 40a and 40b may have various configurations other than those illustrated in FIGS. 7 to 12. The solid lines in FIGS. 7 to 12 may correspond to the first cooling channels 40a, and the dashed lines may correspond to the second cooling channels 40b. The first and second cooling channels 40a and 40b are illustrated using lines for convenience of illustration and description. In FIGS. 7 to 12, the thickness of the line may represent the width of the cooling channels, and the gap between lines may represent the gap between cooling channels.

Referring to FIG. 7, each of the first and second cooling channels 40a and 40b are disposed between a first manifold 60 and a second manifold 62. The input terminals of the first and second cooling channels 40a and 40b are both connected to the first manifold 60. Here, the input terminals may be connected to substantially the same location or different locations within the first manifold 60. A coolant, e.g., cold cooling water, is supplied to the first and second cooling channels 40a and 40b through the first manifold 60. The output terminals of the first and second cooling channels 40a and 40b are both connected to the second manifold 62. In such an embodiment, the output terminals may be connected to the same location or different locations within the second manifold 62. Flowing directions of the cooling water in the first and second cooling channels 40a and 40b may be opposite to each other in a predetermined region, for example, a second region A2. The second region A2 includes an end portion of the first cooling channel 40a and a starting portion of the second cooling channel 40b. In such an embodiment, the temperature of the cooling water flowing through the first cooling channel 40a in the second region A2 is higher than the temperature of the cooling water flowing through the second cooling channel 40b. The temperature of the first and second cooling channels 40a and 40b in a different region, for example, in the region including the starting portion of the first cooling channel 40a and the end portion of the second cooling channel 40b, may be opposite to the temperature in the second region A2.

In such an embodiment, the cooling water flowing through the first cooling channel 40a on one side of the cooling plate 40 has a temperature distribution that compensates (e.g., opposes a temperature distribution of the cooling water flowing through the second cooling channel 40b on the other side of the cooling plate 40. Therefore, an overall temperature distribution of the cooling plate 40 becomes substantially uniform. In such an embodiment, the temperature difference between different regions of the cooling plate 40 is substantially reduced.

In an embodiment, the temperature distribution of the cooling plate 40 becomes substantially uniform, and the cooling of the neighboring cells is thereby performed substantially uniformly over an entire region of the neighboring cells corresponding to the cooling plate 40. In such an embodiment, the cooling of the fuel cell stack including a plurality of cells may be performed substantially uniformly, and chemical reactions may occur substantially uniformly throughout an entire region of the fuel cell stack, thereby substantially improving the performance and durability of the stack.

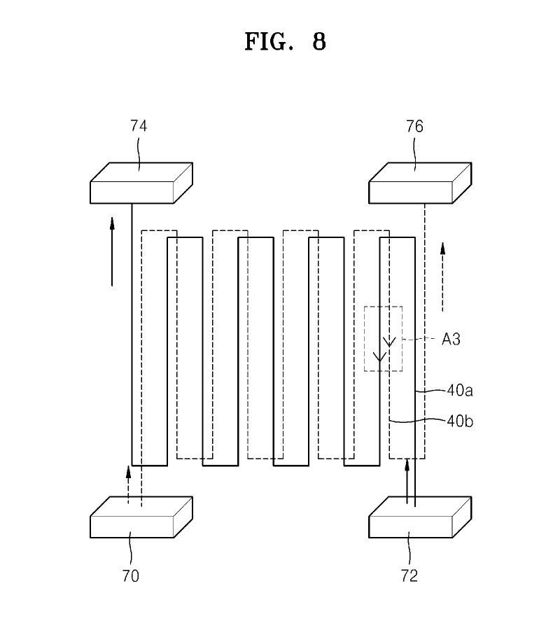

FIG. 8 shows a configuration of an alternative embodiment of the first and second cooling channels 40a and 40b on the cooling plate 40.

Referring to FIG. 8, in an embodiment, the first cooling channel 40a indicated by a solid line may be defined between a fourth manifold 72 and a fifth manifold 74. The input terminal of the first cooling channel 40a may be connected to the fourth manifold 72 and the output terminal of the first cooling channel 40a may be connected to the fifth manifold 74. The cooling water in the first cooling channel 40a flows from the fourth manifold 72 to the fifth manifold 74. In such an embodiment, the second cooling channel 40b indicated by a dashed line may be provided between a third manifold 70 and a sixth manifold 76. The input terminal of the second cooling channel 40b may be connected to the third manifold 70 and the output terminal of the second cooling channel 40b may be connected to the sixth manifold 76. The cooling water in the second cooling channel 40b flows from the third manifold 70 to the sixth manifold 76. The first and second cooling channels 40a and 40b may have a zigzag shape similar to that of the first and second cooling channels 40a and 40b shown in FIG. 7. In such an embodiment, as shown in a third region A3, the direction of the relatively cold cooling water flowing in the first cooling channel 40a may be substantially the same as the direction of the relatively hot cooling water flowing in the second cooling channel 40b. The first and second cooling channels 40a and 40b may be deviated from each other.

In an alternative embodiment, the third manifold 70 and the sixth manifold 76 may be located on a same side, and the fourth manifold 72 and the fifth manifold 74 may be located on a same side. In one embodiment, for example, the sixth manifold 76 may be located at the position of the fourth manifold 72.

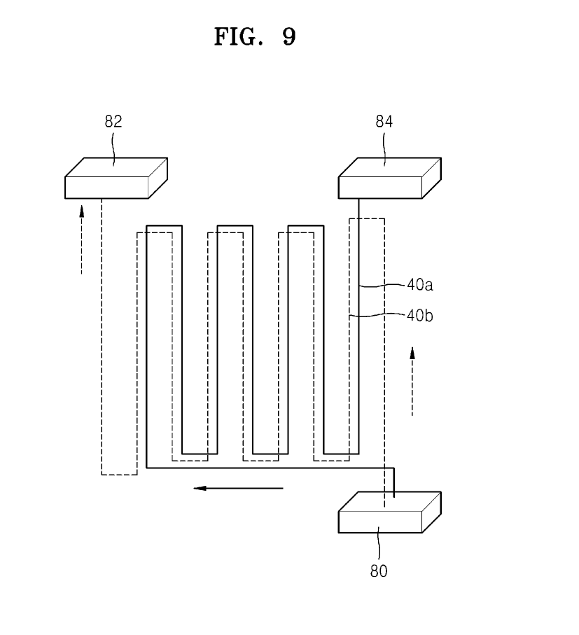

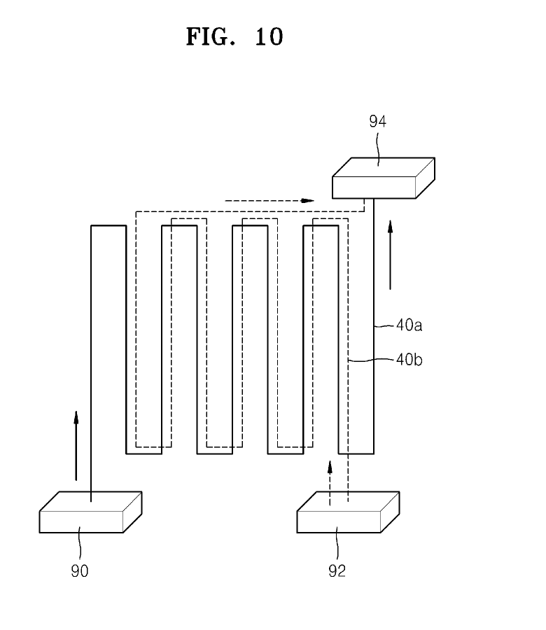

FIGS. 9 and 10 illustrate alternative embodiments, in which three manifolds are connected to the first and second cooling channel 40a and 40b.

First, referring to FIG. 9, the input terminals of the first and second cooling channels 40a and 40b are connected to a single manifold, e.g., a seventh manifold 80. In an embodiment, the first and second cooling channels 40a and 40b extend from the seventh manifold 80 substantially perpendicular to each other. The first and second cooling channels 40a and 40b may have a zigzag shape, and the flow direction of cooling water in each channel in a predetermined region is opposite to each other. The output terminal of the first cooling channel 40a is connected to a ninth manifold 84. The cooling water flowing through the first cooling channel 40a is released to the ninth manifold 84. The output terminal of the second cooling channel 40b is connected to an eighth manifold 82. The cooling water flowing through the second cooling channel 40b is released to the eighth manifold 82. The eighth and ninth manifolds 82 and 84 may be provided on a same side.

Referring to FIG. 10, a tenth manifold 90 and an eleventh manifold 92 may be located on a same side, and a twelfth manifold 94 is provided on a different side from the tenth and eleventh manifolds 90 and 92.

The first cooling channel 40a is defined between the tenth manifold 90 and the twelfth manifold 94. The input terminal of the first cooling channel 40a is connected to the tenth manifold 90. The output terminal of the first cooling channel 40a is connected to the twelfth manifold 94. The second cooling channel 40b is defined between the eleventh manifold 92 and the twelfth manifold 94. The input terminal of the second cooling channel 40b is connected to the eleventh manifold 92. The output terminal of the second cooling channel 40b is connected to the twelfth manifold 94. The twelfth manifold 94 is connected to both the output terminals of the first and second cooling channels 40a and 40b. In a predetermined region, the direction of the cooling water flowing in the first cooling channel 40a may be opposite to the direction of the cooling water flowing in the second cooling channel 40b.

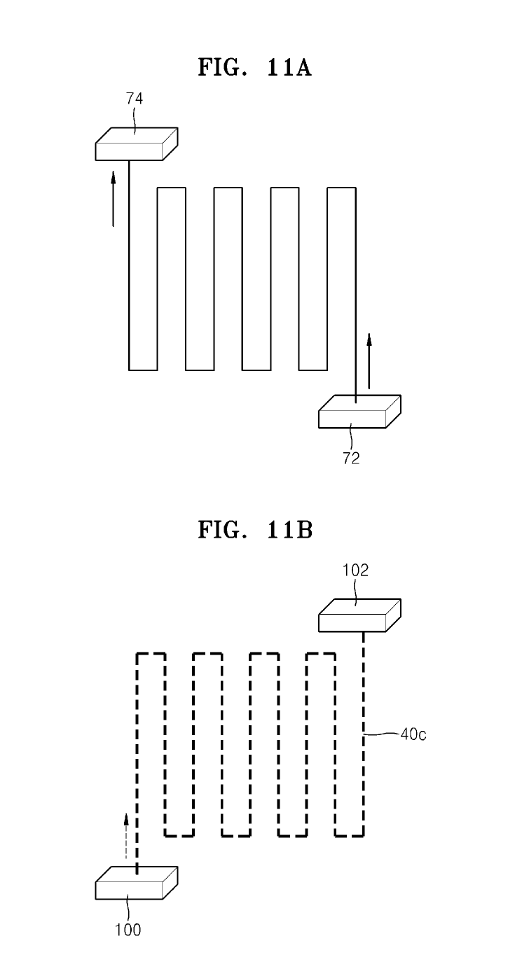

FIGS. 11A and 11B shows another alternative embodiment, in which widths of the cooling channels on opposing surfaces of the cooling plate 40 are different from each other. FIG. 11A shows an arrangement of the first cooling channel 40a, and FIG. 11B shows an arrangement of the second cooling channel 40b.

Referring to FIG. 11A, the first cooling channel 40a is connected to the fourth manifold 72 and the fifth manifold 74. The input terminal of the first cooling channel 40a is connected to the fourth manifold 72, and the output terminal of the first cooling channel 40a is connected to the fifth manifold 74.

Referring to FIG. 11B, the width (line thickness) of a third cooling channel 40c is greater than the width of the first cooling channel 40a. In such an embodiment, the cooling plate 40 may have a predetermined area, and the channel density of the third cooling channel 40c with a greater width is lower than the channel density of the first cooling channel 40a. The input terminal of the third cooling channel 40c is connected to a thirteenth manifold 100. The output terminal of the third cooling channel 40c is connected to a fourteenth manifold 102. The third cooling channel 40c may have a zigzag shape. The thirteenth and fourteenth manifolds 100 and 102 may be provided on different sides from each other with respect to the third cooling channel 40c located therebetween.

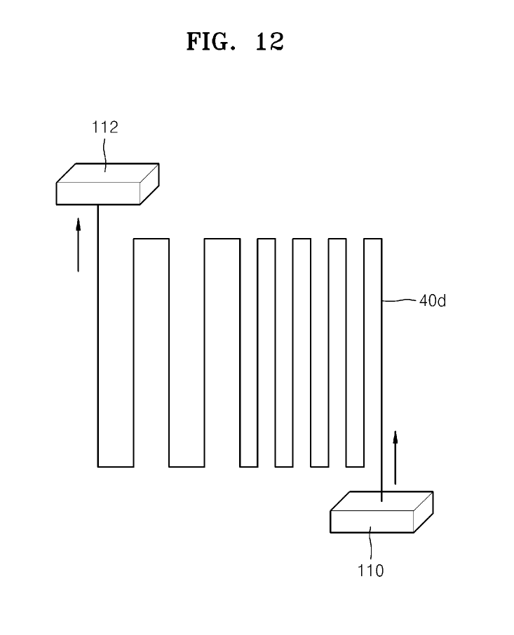

FIG. 12 shows an embodiment, in which the density of the cooling channels at one side of the cooling plate 40 varies depending on regions.

Referring to FIG. 12, a fourth cooling channel 40d is arranged between a fifteenth manifold 110 and a sixteenth manifold 112. In such an embodiment, the input terminal of the fourth cooling channel 40d may be connected to the fifteenth manifold 110, and the output terminal of the fourth cooling channel 40d may be connected to the sixteenth manifold 112. In an alternative embodiment, the input terminal of the fourth cooling channel 40d may be connected to the sixteenth manifold 112, and the output terminal of the fourth cooling channel 40d is connected to the fifteenth manifold 110. The fourth cooling channel 40d located between the fifteenth and sixteenth manifolds 110 and 112 may have a zigzag shape. The channel density of the fourth cooling channel 40d may vary depending on the region of the cooling plate 40. In one embodiment, for example, when the channel width of the fourth cooling channel 40d is constant, the channel density of a half of the fourth cooling channel 40d may be higher than the channel density of the other half.

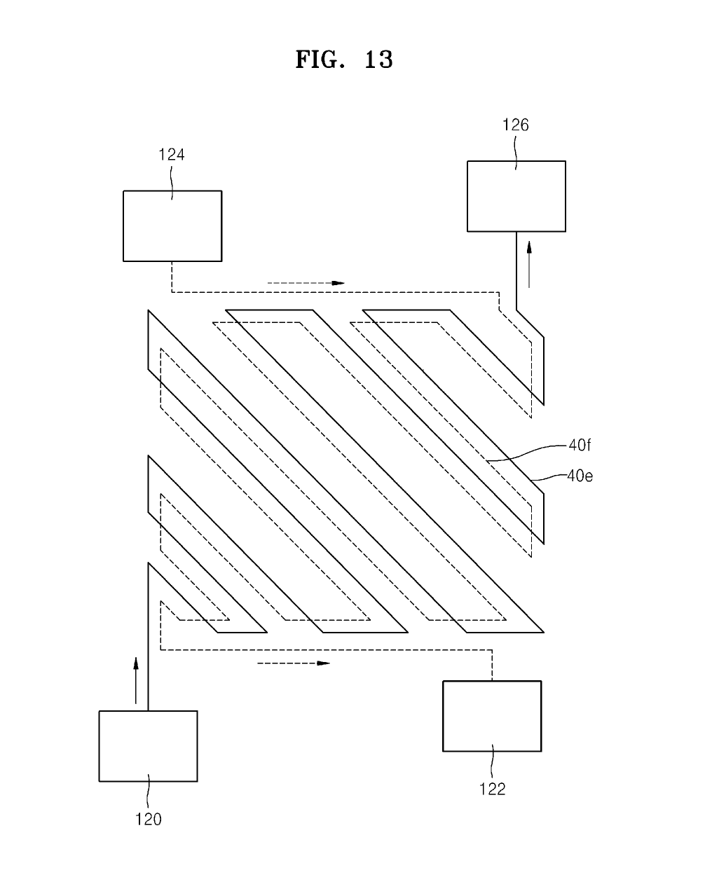

FIG. 13 shows an embodiment in which the cooling channel is defined substantially in a diagonal direction in the cooling plate 40.

Referring to FIG. 13, a fifth cooling channel 40e is defined between seventeenth and twentieth manifolds 120 and 126. A sixth cooling channel 40f is defined between eighteenth and nineteenth manifolds 122 and 124. The fifth cooling channel 40e may be on one side of the cooling plate 40, and the sixth cooling channel 40f may be on the other side of the cooling plate 40. The input terminal of the fifth cooling channel 40e is connected to the seventeenth manifold 120 and the output terminal of the fifth cooling channel 40e is connected to the twentieth manifold 126. The input terminal of the sixth cooling channel 40f is connected to the nineteenth manifold 124, and the output terminal of the sixth cooling channel 40f is connected to the eighteenth manifold 122. The seventeenth and eighteenth manifolds 120 and 122 may be provided at one side while the nineteenth and twentieth manifolds 124 and 126 may be provided together on the other side.

The fifth and sixth cooling channels 40e and 40f may have a zigzag shape and include portions inclined with respect to a horizontal or vertical direction. In such an embodiment, the fifth and sixth cooling channels 40e and 40f may be inclined at an angle of about 45 degrees with respect to the horizontal direction. In such an embodiment, the gap between the inclined portions of the fifth and sixth cooling channels 40e and 40f may be the same or vary depending on the region.

Embodiments of the fuel cell stack may be, for example, a polymer electrolyte membrane fuel cell (“PEMFC”) stack, or another type of fuel cell stack. The cooling plate 40 may be included in any fuel cell which includes a cooling plate. The cooling plate 40 may be provided between a plurality of cells, and the number of the cooling plates provided between the cells may be less than the number of the cells.

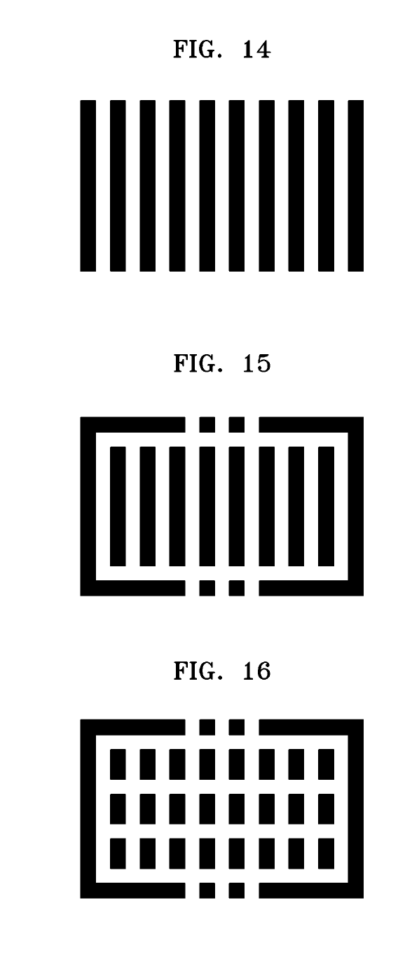

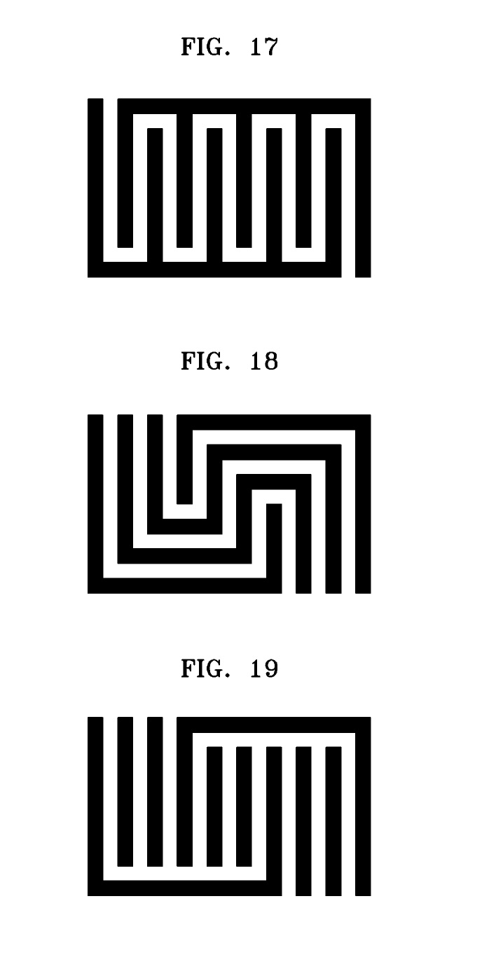

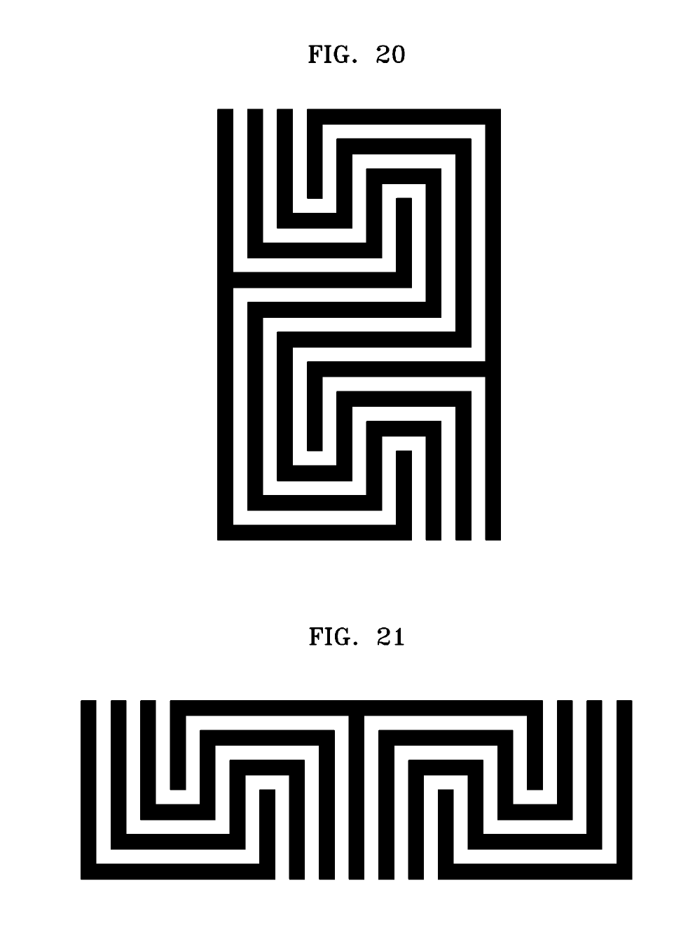

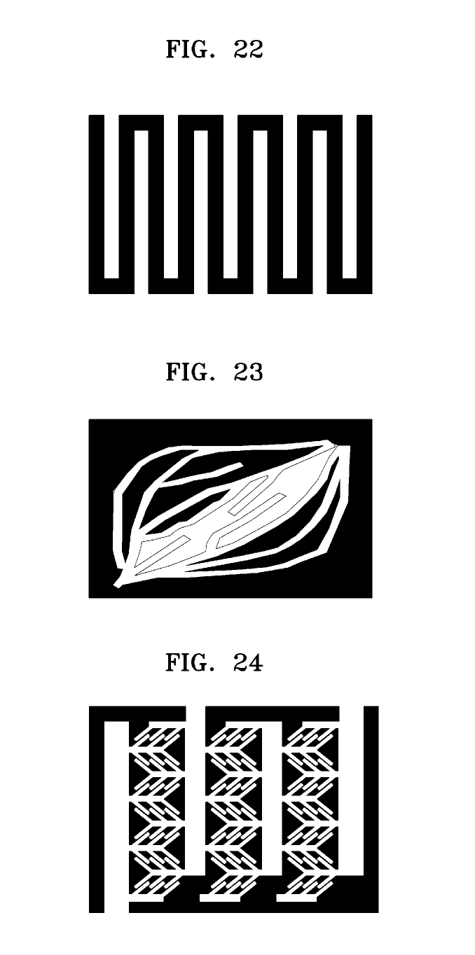

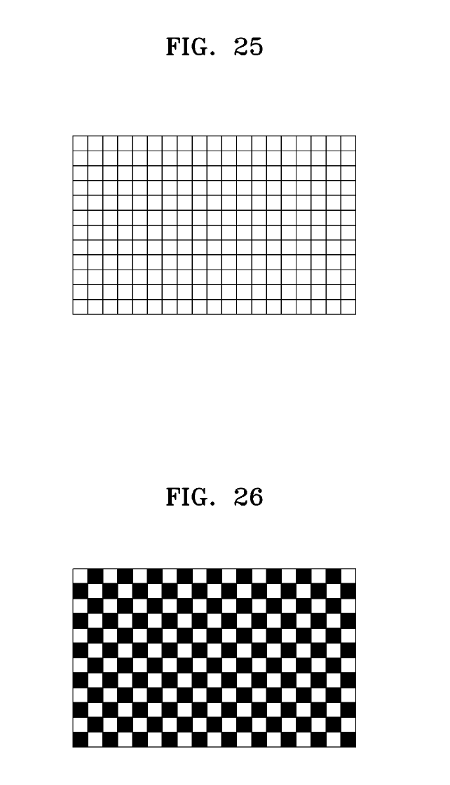

In such embodiments, various types of cooling channels may be provided in the cooling plate 40, for example, as illustrated in FIGS. 14 to 26, a linear type (FIGS. 14 and 15), a crisscross type (FIG. 16), a single serpentine type (FIG. 17), a multi-channel serpentine type (FIG. 18), a mixed serpentine type (FIG. 19), a subsequent serpentine type (FIG. 20), a mirror serpentine type (FIG. 21), an interdigitated type (FIG. 22), a fractal (FIG. 23), a biomimetic type (FIG. 24), a screen/mesh type (FIG. 25) and a porous type (FIG. 26).

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A fuel cell stack comprising:
a first separating plate,
a second separating plate corresponding to the first separating plate,
a plurality of cells comprising a membrane electrode assembly disposed between the first separating plate and the second separating plate, and
a cooling plate disposed between the plurality of cells,
wherein a cooling channel is defined at opposing surfaces of the cooling plate.

2. The fuel cell stack according to claim 1, further comprising:
a blocking plate disposed between the cooling plate and a cell neighboring the cooling plate.

3. The fuel cell stack according to claim 1, wherein
the cooling channel comprises:
a first cooling channel defined in a first surface of the cooling plate; and
a second cooling channel defined in a second surface of the cooling plate, and
the first and the second cooling channels are arranged such that a high temperature portion of the first cooling channel corresponds to a low temperature portion of the second cooling channel.

4. The fuel cell stack according to claim 3, wherein the first cooling channel and the second cooling channel have a zigzag shape.

5. The fuel cell stack according to claim 3, wherein the first cooling channel and the second cooling channel are arranged in a crisscross, interdigitated, biomimetic or fractal form.

6. The fuel cell stack according to claim 3, wherein
a direction of a coolant flowing through the first cooling channel in a predetermined region of the cooling plate is substantially the same as or substantially opposite to a direction of a coolant flowing through the second cooling channel in the predetermined region of the cooling plate.

7. The fuel cell stack according to claim 3, wherein a width of the first cooling channel is substantially the same as or different from a width of the second cooling channel.

8. The fuel cell stack according to claim 3, wherein at least one of the first cooling channel and the second cooling channel has a channel density which varies depending on a region of the cooling plate.

9. The fuel cell stack according to claim 4, wherein each of the first cooling channel and the second cooling channel comprises an inclined portion.

10. The fuel cell stack according to claim 3, wherein input terminals of both the first cooling channel and the second cooling channel are connected to a same manifold.

11. The fuel cell stack according to claim 10, wherein output terminals of both the first cooling channel and the second cooling channel are connected to a same manifold.

12. The fuel cell stack according to claim 10, wherein output terminals of the first cooling channel and the second cooling channel are connected to different manifolds.

13. The fuel cell stack according to claim 3, wherein input terminals of the first cooling channel and the second cooling channel are connected to different manifolds.

14. The fuel cell stack according to claim 13, wherein output terminals of both the first cooling channel and the second cooling channel are connected to a same manifold.

15. The fuel cell stack according to claim 13, wherein output terminals of the first cooling channel and the second cooling channel are connected to different manifolds.

16. The fuel cell stack according to claim 2, wherein
the cooling channel comprises:
a first cooling channel defined in a first surface of the cooling plate; and
a second cooling channel defined in a second surface of the cooling plate, and
the first and the second cooling channels are arranged such that a high temperature portion of the first cooling channel corresponds to a low temperature portion of the second cooling channel.
